(19) United States
(12) Patent Application Publication
(10) Pub. No.: US 2009/0002621 A1
(43) Pub. Date: Jan. 1, 2009

(54) Transparent Electrode and Liquid Crystal Display Device Provided With the Same

(76) Inventor: Ryoji Minakata, Nara (JP)

Correspondence Address: EDWARDS ANGELL PALMER & DODGE LLP, P.O. BOX 55874, BOSTON, MA, 02205, US

(21) Appl. No.: 11/664,983

(22) PCT Filed: Oct. 3, 2005
(86) PCT No.: PCT/JP05/18263

§ 371 Date: Apr. 6, 2007

(30) Foreign Application Priority Data
Oct. 7, 2004 (JP) 2004-294974

(51) Int. Cl. G02F 1/1343

(52) U.S. Cl. 349/141

(57) ABSTRACT

A transparent electrode (4) is made of an electrically conductive material and has a plurality of linear portions (22) extending substantially parallel to each other, and at least a part of the linear portions (22) are electrically connected to each other. Preferably, the linear portions (22) are formed with a pitch therebetween of at most a wavelength of visible radiation, and the linear portions (22) are formed each with a width of at most one half of the pitch.

### TECHNICAL FIELD

The present invention relates to a transparent electrode and a liquid crystal display device provided with the transparent electrode.

### BACKGROUND ART

Some devices such as display devices have a polarizing plate attached thereto. For example, some liquid crystal display devices have a linear polarizing plate attached to a surface of a liquid crystal display panel. A polarizing plate that is commonly used for a liquid crystal display panel includes a stretched plastic film in which iodine is adsorbed and aligned for example and plastic plates sandwiching the plastic film therebetween for holding it. The linear polarization capability of such a polarizing plate is obtained by dichroism of the aligned iodine. Besides the iodine, a dye or the like having a similar linear polarization capability is used for the polarizing plate.

Japanese Patent Laying-Open No. 2004-157159 discloses a wire-grid type polarizing plate. This polarizing plate includes a glass substrate having a surface in which a one-dimensional line grating of an electrically conductive material is embedded. It is disclosed that this wire-grid type polarizing grating has a simplified structure and can have improved heat resistance and mechanical strength.

FIG. 4 shows a schematic cross-sectional view of a liquid crystal display device that is a device using a polarizing plate. The liquid crystal display device is configured to have two substrates that are glass substrates 1, 2 between which a liquid crystal 16 is enclosed. On one glass substrate 1, a transparent electrode 11 of ITO (Indium Tin Oxide) for example is formed. On the other glass substrate 2 as well, a transparent electrode 12 is formed. On respective surfaces of transparent electrodes 11, 12, protective films 14, 15 are formed respectively. Thus, the liquid crystal display device has the arrangement in which liquid crystal 16 is sandwiched between two transparent electrodes 11, 12.

Glass substrate 1 has main surfaces including a main surface where transparent electrode 11 is disposed and an opposite main surface where a polarizing plate 18 is disposed. Glass substrate 2 also has main surfaces including a main surface where transparent electrode 12 is disposed and an opposite main surface where a polarizing plate 19 is disposed. Polarizing plates 18, 19 here are linear polarizing plates.

On the outside of polarizing plate 19, a backlight (not shown) is disposed as a light source. A voltage applied between two transparent electrodes 11, 12 causes liquid crystal 16 to be aligned. By means of an appropriately set polarization direction of two polarizing plates 18, 19 and the alignment of liquid crystal 16, the brightness of the light of the backlight can be adjusted.

Glass substrate 2 has a surface where TFTs (Thin Film Transistors) are formed in an arranged state (not shown). By driving the TFTs, the liquid crystal of respective pixels is driven. Further, on a main surface of glass substrate 1, for example, a color filter is disposed to provide color display. Alternatively, in order to improve the display quality, an optical compensation plate is inserted at the position between two polarizing plates 18, 19, or an anti-reflection film is formed on a surface of the polarizing plate disposed on the front side of the display device.

In the conventional liquid crystal display device using the polarizing plates, such components as transparent electrodes, TFTs and color filter are directly formed on the main surface of the substrate, while the polarizing plates are formed separately from the substrates and attached to the substrates afterwards. Therefore, for the polarizing plate, a plastic plate or the like is required for holding the polarizing plate. In addition, after the liquid crystal is enclosed between the two substrates, the polarizing plate has to be bonded to the substrate.

Japanese National Patent Publication No. 2001-504238 discloses a method of forming a polarizing element on a main surface of a glass substrate by directly applying a thin film of a dichroic dye having aligned molecules.

Patent Document 1: Japanese Patent Laying-Open No. 2004-157159

Patent Document 2: Japanese National Patent Publication No. 2001-504238

### DISCLOSURE OF THE INVENTION

### Problems to be Solved by the Invention

Regarding such a conventional device including a polarizing plate as a liquid crystal display device, a member such as a plastic plate is required for attaching the polarizing plate, and a bonding process for bonding the polarizing plate is necessary.

As for the polarizing element disclosed in Japanese National Patent Publication No. 2001-504238, the polarizing element can be formed directly on a surface of a glass substrate and thus a holding plastic plate or the like is unnecessary. However, the polarizing element is disposed between the glass substrate and the liquid crystal, resulting in a problem that the structure is complicated. Further, for the dichroic dye's alignment, a special application method is required, resulting in a problem that the number of manufacturing processes as a whole is not considerably reduced. Moreover, since a special pigment is used for forming the polarizing element, a remarkable cost reduction cannot be expected.

### Means for Solving the Problems

An object of the present invention is to provide a transparent electrode for which a polarizing plate is unnecessary as well as a liquid crystal display device having the transparent electrode.

According to the present invention, a transparent electrode is made of an electrically conductive material and has a plurality of linear portions extending substantially parallel to each other, and at least a part of the linear portions are electrically connected to each other. This configuration can be employed to provide the transparent electrode requiring no polarizing plate, simplify the device configuration and reduce the number of manufacturing processes.

According to the present invention, preferably the linear portions are formed with a pitch therebetween of at most a wavelength of visible light, and the linear portions are formed each with a width of at most a half of the pitch. This configuration can be employed to add the polarization capability for visible light.

According to the present invention, a liquid crystal display device has the transparent electrode as described above. This configuration can be employed to provide the liquid crystal display device that has a simple configuration and that is manufactured through a smaller number of manufacturing processes.

### EFFECTS OF THE INVENTION

In accordance with the present invention, a transparent electrode for which a polarizing plate is unnecessary as well as a liquid crystal display device having the transparent electrode can be provided.

### BRIEF DESCRIPTION OF THE DRAWINGS

FIG. 1 is a schematic plan view of a transparent electrode according to the present invention.

FIG. 2 is a schematic enlarged plan view of the transparent electrode according to the present invention.

FIG. 3 is a schematic enlarged cross-sectional view of a liquid crystal display device according to the present invention.

FIG. 4 is a schematic enlarged cross-sectional view of a liquid crystal display device based on the conventional art.

### DESCRIPTION OF THE REFERENCE SIGNS

1, 2 glass substrate, 4, 7, 11, 12 transparent electrode, 5, 6, 14, 15 protective film, 16 liquid crystal, 18, 19 polarizing plate, 21, transmissive portion, 22 linear portion, 23 connecting portion, 31, 32 arrow

### BEST MODES FOR CARRYING OUT THE INVENTION

Referring to FIGS. 1 to 3, a transparent electrode and a liquid crystal display device are described according to an embodiment of the present invention.

FIG. 1 is a schematic plan view of a transparent electrode in the present embodiment. According to the present invention, an electrode having the functions of an electrode and transmitting light in at least a part of a particular wavelength region so that the light incident on one side can be recognized on the other side is referred to as “transparent electrode.” The transparent electrode shown in FIG. 1 is a transparent electrode provided to a liquid crystal display device for transmitting visible light. In FIG. 1, the portion shown corresponds to substantially two pixels.

Transparent electrode 4 in the present embodiment is formed on a surface of a glass substrate 1. Transparent electrode 4 is flat-shaped. Transparent electrode 4 is made of an electrically conductive material. In the present embodiment, transparent electrode 4 is made of a metal. The transparent electrode is not particularly limited to this form and may be any as long as the transparent electrode is made of an electrically conductive material. For example, the transparent electrode may be made of a semiconductor material to which impurities are added and which has high electrical conductivity.

Transparent electrode 4 includes a plurality of linear portions 22 extending substantially parallel to each other. Linear portions 22 are straight-line shaped and formed to have a substantially constant intervals therebetween. Between linear portions 22, a transmissive portion 21 is formed. Transmissive portion 21 is slit-shaped.

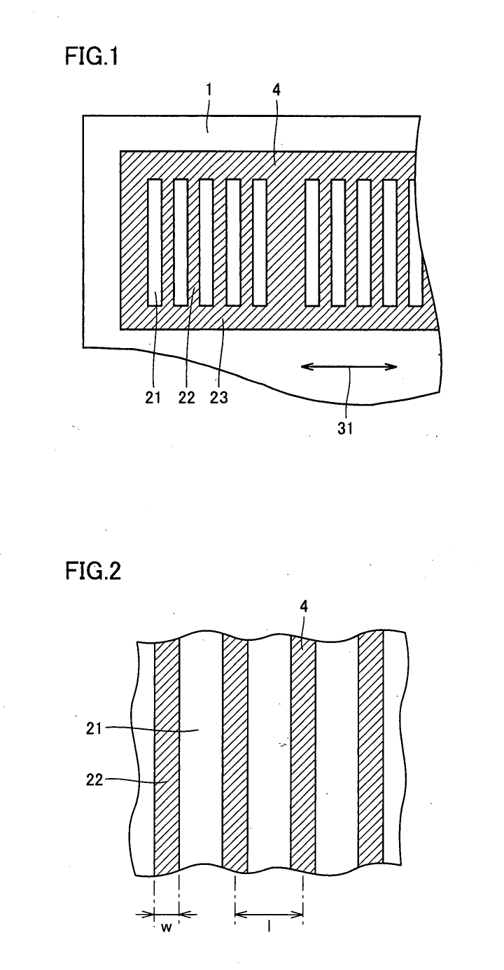

FIG. 2 shows a schematic enlarged plan view of a portion including the linear portions and transmissive portions. Transparent electrode 4 is formed with a pitch 1 between linear portions 22 that is at most a wavelength of visible light. Transparent electrode 4 is formed with a width w of linear portions 22 each that is at most a half of pitch 1. In the present embodiment, transparent electrode 4 is formed with pitch 1 between linear portions 22 that is at least 100 nm and at most 400 nm. Further, the transparent electrode is formed with width w of linear portions 22 each that is at least 20 nm and at most 200 nm.

Referring to FIG. 1, linear portions 22 are electrically connected at a connecting portion 23 formed in a peripheral portion of transparent electrode 4. In the present embodiment, linear portions 22 and connecting portion 23 are formed as a single piece. It is unnecessary that linear portions 22 and connecting portion 23 are formed as a single piece as long as they are electrically connected to each other. Further, it is unnecessary that all linear portions 22 are electrically connected as long as at least a part of linear portions 22 are connected to each other.

Transparent electrode 4 in the present embodiment is a transparent electrode of an STN (Super Twisted Nematic) liquid crystal display device and is a transparent electrode for driving the liquid crystal by the simple matrix drive system. The transparent electrode is band-shaped to have the longitudinal direction. In FIG. 1, transparent electrode 4 extends in the direction indicated by an arrow 31. In a liquid crystal display device of the present embodiment, two transparent electrodes having respective longitudinal directions orthogonal to each other are formed.

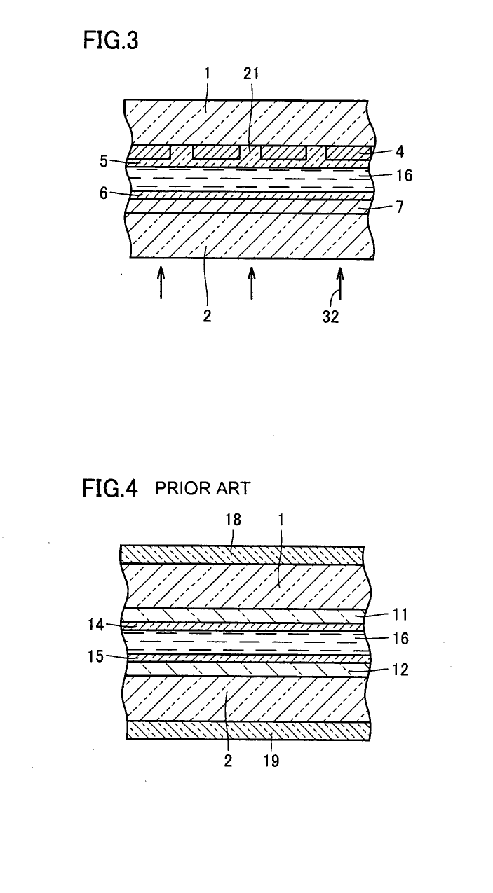

FIG. 3 shows a schematic cross-sectional view of the liquid crystal display device having the transparent electrode in the present embodiment. The liquid crystal display device includes two glass substrates 1, 2. On a surface of glass substrate 1, transparent electrode 4 is disposed. On a surface of transparent electrode 4, a protective film 5 is disposed. As protective film 5, a resin for example for planarizing the surface is formed. The linear portions of transparent electrode 4 are formed to extend in the direction perpendicular to the plane of the drawing.

On a surface of glass substrate 2, a transparent electrode 7 is formed that has a plurality of linear portions similar to those of transparent electrode 4. Transparent electrode 7 is formed so that the longitudinal direction of the linear portions of transparent electrode 4 and the longitudinal direction of the linear portions of transparent electrode 7 are orthogonal to each other. In FIG. 3, the linear portions of transparent electrode 7 are formed to extend in the direction parallel to the plane of the drawing. On a surface of transparent electrode 7, a protective film 6 is formed and the surface is planar.

As protective films 5, 6, polyimide films are formed as alignment films, and their surfaces may be scribed to allow enclosed liquid crystal 16 to be aligned in an appropriate direction. Alternatively, as protective films 5, 6, such insulating oxide films as SiO₂ may be formed.

Between protective film 5 and protective film 6, liquid crystal 16 is disposed. Liquid crystal 16 is disposed in the sandwiched state between transparent electrode 4 and transparent electrode 7. Two glass substrates 1, 2 are attached by means of a sealing material (not shown) so that respective main surfaces are in parallel to each other.

On the outside of glass substrate 2, a backlight (not shown) is disposed. The backlight is formed so that it can emit light in the direction indicated by an arrow 32. In the present embodiment, pixels are formed at the portions where transparent electrode 4 and transparent electrode 7 cross each other in plan view.

Referring to FIG. 3, in the liquid crystal display device of the present embodiment, an appropriate voltage applied between transparent electrode 4 and transparent electrode 7 causes liquid crystal 16 to be aligned. The light from the backlight indicated by arrow 32 is passed through the transmissive portion of transparent electrode 7 and the transmissive portion of transparent electrode 4, and the polarization capability of liquid crystal 16 adjusts the amount of transmission according to an applied electrical signal. Therefore, the transmission amount of the light from the backlight is adjusted while the light is passed through transparent electrode 7, liquid crystal 16 and transparent electrode 4, and accordingly a desired brightness change is made.

Referring to FIG. 1, transparent electrode 4 in this embodiment includes a plurality of linear portions 22 extending substantially parallel to each other, and linear portions 22 are electrically connected to each other. By employing this configuration, transmissive portion 21 in the shape of a slit can be formed and the transparent electrode can be formed through which light is transmitted while being polarized according to the size of the transmissive portion. In other words, the transparent electrode can be provided that has the polarization capability for predetermined light.

Referring to FIG. 2, in the present embodiment, linear portions 22 are formed with pitch l therebetween that is smaller than visible light and with width w of linear portion 22 that is at most a half of the pitch. By employing this configuration, the transparent electrode can be provided that has the capability of the polarizer for visible light.

Since the transparent electrode in the present embodiment has the polarization capability, the polarizing plate used by the conventional art is unnecessary. Further, a plastic plate or the like for attaching the polarizing plate to the substrate and for holding the polarizing plate is unnecessary. As a result, the number of components is reduced. Furthermore, the number of steps of the manufacturing process can be reduced and a low-cost liquid crystal display device can be provided.

In connection with the present embodiment, the description is given using a monochrome liquid crystal display device as an example. The prevent invention, however, is not particularly limited to this form, and is applicable to a color liquid crystal display device having a color filter disposed on one of the glass substrates. Alternatively, an optical compensation film may be formed on a surface of the transparent electrode of the present invention. By employing the optical compensation film, the display quality can be improved.

Further, in connection with the present embodiment, the transparent electrodes are illustrated as two electrodes that are band-shaped to have the longitudinal direction and sandwich the liquid crystal therebetween. Here, the electrodes are disposed in the form of stripes orthogonal to each other. The present invention, however, is not particularly limited to this form and any shape of the electrode may be employed. For example, in the case where a TFT array is formed on one of the glass substrates, a metal film for interconnection can be used for each pixel to form a transparent electrode based on the present invention. On the other glass substrate, a transparent electrode can be formed based on the present invention to cover all of a plurality of pixels. Alternatively, the transparent electrode of the present invention may be formed on only one of the substrates.

In the case where the transparent electrode of the present invention is used for a display device using a color filter, such an electrically conductive material having a low reflectance as chromium may be used to form a black matrix portion correspondingly to the periphery of each color region of the color filter. In other words, instead of forming a black matrix portion on the color filter, the black matrix portion can be formed on the transparent electrode.

Regarding the absorption-type polarizing plate based on the conventional art, light that does not pass through the polarizing plate is absorbed by the polarizing plate. In contrast, regarding the transparent electrode of the present invention, light that does not pass through the transparent electrode is reflected. Therefore, in the case of a liquid crystal display device for example, when the transparent electrode of the present invention is used as an electrode on the side where the backlight is disposed, the light reflected from the transparent electrode is reflected by the backlight with a different polarization state and thus can be used again. Therefore, as compared with the conventional absorption-type polarizing plate, the brightness can be improved.

In connection with the present embodiment, the transmissive liquid crystal display device is described as an example. The present invention, however, is not limited to this form and is applicable to a reflective or semi-transmissive liquid crystal display device. Further, the present invention is not limited to a direct-view type liquid crystal display device and is applicable as well to a projection type liquid crystal display device. Furthermore, the transparent electrode of the present invention is not limited to an electrode for the liquid crystal display device and may be applied as a window electrode of such a light-emitting device as LED (Light Emitting Diode) for example.

In the following, a description is given of a method of manufacturing the transparent electrode in the present embodiment and the results of a performance test of the manufactured transparent electrode.

Referring to FIG. 1, on a main surface of glass substrate 1, an Al film is deposited to a thickness of 300 nm as a metal film of transparent electrode 4, by means of a spattering apparatus. As a substrate having a surface on which the transparent electrode is to be formed, a plastic substrate or the like may be used instead of the glass substrate. Further, as a material for the metal film of the transparent electrode, such a metal as Cr, Mo, Ti, Nd or Zr instead of Al or an alloy of any of these metals may be used. Alternatively, a multilayer film having these materials stacked on each other may be used. Furthermore, as a method of depositing the metal film, the vapor deposition method, plating method or P-CVD (Plasma Chemical Vapor Deposition) method for example may be used instead of the sputtering method.

Then, on a surface of the deposited metal film, a PMMA film (polymethylmethacrylate film) is formed as a resist. Next, the electron beam lithography method is used to form the resist corresponding in shape to the shape of the electrode shown in FIG. 1. As a method of forming a resist pattern, the lithography method using X-ray or excimer laser may be used instead of the electron beam lithography method. Alternatively, a photolithography method used for forming a sub-micron pattern in a manufacturing process of an LSI (Large Scale Integration) may be used. For each lithography method, it is preferable to select an appropriate resist material. Alternatively, as a simple and low-cost method, the nanoimprint method may be used to transfer a pattern.

Regarding the resist in the present embodiment, the resist is formed to have a pitch of resist openings of approximately 300 nm and have a width of an opening of approximately 270 nm. Then, the RIE (Reactive Ion Etching) method is used to etch the Al film. As an etching gas, such a chlorine-based gas as BCl₃ and Cl₂ is used to etch a portion that is not coated with the resist.

As a method of etching the metal film, any dry etching method other than the RIE may be used. Alternatively, the wet etching may be used. However, since the width of the opening of the resist is small, the dry etching is preferably used in the etching process for the transparent electrode.

After the etching process, the resist may be removed to fabricate the transparent electrode formed of the metal film. As a method of removing the resist, any of the known wet removing and dry removing may be used.

In the case where an insulating oxide film is formed as a protective film, such a known method as vapor deposition or sputtering method may be used to form the film. In the case where a resin film is formed as a protective film, such a known method as spin-on method may be used to form the film.

A test was conducted on the polarization capability of the transparent electrode obtained in this way. Measurements were taken for the polarization characteristics over a range of the light wavelength of 400 nm to 700 nm. As a result, for linearly polarized light, the parallel transmittance was 90% or higher and the cross transmittance was 0.02% or lower. Thus, favorable results were obtained. The polarizing plate of the conventional art having a stretched plastic film in which iodine is adsorbed and aligned has, for example, a parallel transmittance of approximately 80% and a cross transmittance of 0.05% or lower for linearly polarized light. From this fact, it is seen that the polarization capability of the transparent electrode of the present invention is excellent.

The embodiments as disclosed herein are by way of illustration and example in all respects, and are not to be taken by way of limitation. It is intended that the scope of the present invention is defined by claims, not by the description above, and includes all modifications within the meaning and range equivalent to that of the claims.

### INDUSTRIAL APPLICABILITY

The present invention is advantageously applicable to a display device including a transparent electrode.

1-3. (canceled)

4. A liquid crystal display device comprising:
a color filter; and
a transparent electrode made of an electrically conductive material and having a plurality of linear portions extending substantially parallel to each other, at least a part of said linear portions being electrically connected to each other, wherein:
said linear portions are formed with a pitch therebetween of at most a wavelength of visible light,
said liner portions are formed each with a width of at most a half of said pitch, and
said transparent electrode includes a black matrix portion formed correspondingly to a periphery of said color filter.

5. A liquid crystal display device comprising:
two glass substrates;
a backlight; and
a transparent electrode disposed on one of said two glass substrates that is located in a side where said backlight is disposed, said transparent electrode being made of an electrically conductive material and having a plurality of linear portions extending substantially parallel to each other and at least a part of said linear portions being electrically connected to each other, wherein:
said linear portions are formed with a pitch therebetween of at most a wavelength of visible light, and
said liner portions are formed each with a width of at most a half of said pitch.
